(19) United States
(12) Patent Application Publication
(10) Pub. No.: US 2019/0041892 A1
(43) Pub. Date: Feb. 7, 2019

(54) INPUT DEVICE

(71) Applicant: Panasonic Intellectual Property Management Co., Ltd., Osaka (JP)

(72) Inventor: Shinichi WADA, Osaka (JP)

(21) Appl. No.: 16/073,853

(22) PCT Filed: Sep. 28, 2016
(86) PCT No.: PCT/JP2016/004368

§ 371 Date: Jul. 30, 2018

(30) Foreign Application Priority Data
Feb. 26, 2016 (JP) 2016-035483
Jun. 14, 2016 (JP) 2016-118244

(51) Int. Cl. G05G 1/02; G05G 5/05; F16H 25/18

(52) U.S. Cl. CPC G05G 1/025; G05G 2505/00; F16H 25/18; G05G 5/05

(57) ABSTRACT

In an input device, a plurality of cam parts are provided at intervals in a circumferential direction of a device main body and first and second boss parts to be engaged with cam parts are respectively provided at intervals in a circumferential direction of rotor that lifts or lowers together with a slider. When the slider is caused to lift or lower by pushing operation or cancellation of the pushing operation of an operating unit, the cam parts of the device main body guide the boss parts of the rotor to thereby cause the rotor to turn with respect to the slider to lift or lower a presser.

### TECHNICAL FIELD

The present invention relates to an input device for generating a signal by input operation.

### BACKGROUND ART

Conventionally, as an input device capable of detecting presence or absence of pushing operation by a switch, there is a known input device shown in Patent Literature 1, for example.

Patent Literature 1 discloses the input device including a body partitioned into an upper housing part and a lower housing part with a push-operable touch panel integrated into the upper housing part and a push operation mechanism and a link mechanism integrated into the lower housing part. The push operation mechanism is provided with a rod-shaped stabilizer that suppresses tilting of the touch panel in push operation and paired bent chips that has substantially C shapes and are respectively attached to paired guide chips of the touch panel are formed at opposite ends of the stabilizer. The link mechanism is provided with a rod-shaped shaft that crosses the stabilizer at an intermediate portion and paired bent chips that are respectively attached to paired connecting chips of the touch panel are formed at opposite ends of the shaft, the connecting chips having substantially C shapes.

### CITATION LIST

### Patent Literature

PTL 1: Unexamined Japanese Patent Publication No. 2014-182718

### SUMMARY OF THE INVENTION

In the present disclosure, in the input device, attitudes of a presser in lifting and lowering operations are maintained by conversion of parts of forces, that are generated by pushing operation and cancellation of the pushing operation, into forces in rotating directions by use of cam mechanisms.

Specifically, the input device according to an exemplary embodiment of the present invention includes: a device main body; an operating unit that forms a housing space between the device main body and the operating unit and that is able to be pushed downward toward the device main body; a switch unit provided to the device main body; and a slider disposed in the housing space and housed so as not to be able to turn and so as to be able to lower or lift in a direction toward or away from the device main body as a result of the pushing operation or the cancellation of the pushing operation of the operating unit. The input device further includes: a presser that is provided to the slider and caused to press the switch unit by the pushing operation of the operating unit; a rotor that is provided to be able to turn with respect to the slider and has a plurality of engagement parts disposed at an interval or intervals in a circumferential direction; and a biasing member that biases the slider toward the operating unit. The device main body has a plurality of cam parts that respectively guide the engagement parts to turn the rotor with respect to the slider to lift or lower the presser when the slider is caused to lift or lower by the pushing operation or the cancellation of the pushing operation of the operating unit.

According to the present disclosure, the slider that is moved toward or away from the device main body by the pushing operation or the cancellation of the pushing operation of the operating unit and the rotor that turns with respect to the slider are provided and the respective cam parts of the device main body are caused to guide the respective engagement parts of the rotor to thereby control an attitude of the presser in the housing space. As a result, whichever position of the operating unit is pushed, the lowering of the presser is maintained stably and the switch unit is pressed appropriately. In the lifting of the presser as a result of the cancellation of the pushing operation, the presser returns to an original position in a stably controlled attitude. As a result, with simple cam mechanisms, it is possible to make user's operational feelings uniform.

### BRIEF DESCRIPTION OF DRAWINGS

FIG. 1 is a perspective view of an input device according to a first exemplary embodiment of the present invention.

FIG. 2 is an exploded perspective view of the input device according to the first exemplary embodiment of the present invention.

FIG. 3 is a perspective view of a device main body seen from above.

FIG. 4 is a schematic perspective view of main structures of the device main body seen from above.

FIG. 5 is a plan view of the device main body.

FIG. 6 is a perspective view of a substrate seen from above.

FIG. 7 is a perspective view of a slider seen from above.

FIG. 8 is a perspective view of the slider seen from below.

FIG. 9 is a perspective view of a rotor seen from above.

FIG. 10 is a plan view of the rotor.

FIG. 11 is a schematic view of the rotor housed in the device main body and corresponding to FIG. 4.

FIG. 12 is a perspective view of the rotor and a biasing member disposed on a lower side of the slider and seen from below.

FIG. 13 is a perspective view of the slider, the rotor, and the biasing member housed in the device main body and seen from above.

FIG. 14 is a schematic view of a state of engagement of a first boss part and a first cam part with each other.

FIG. 15 is a schematic view of a state of engagement of a second boss part and a second cam part with each other.

FIG. 16 is a vertical sectional view of the input device in an OFF state before a presser presses a switch unit.

FIG. 17 is a view of an ON state when the presser presses the switch unit and corresponding to FIG. 16.

FIG. 18 is a view of a modification of the rotor and corresponding to FIG. 10.

FIG. 19 is a schematic view of modifications of the first and second boss parts and a state of engagement of the first boss part and the first cam part with each other.

FIG. 20 is a view of a state of engagement of the second boss part and the second cam part with each other in the modifications in FIG. 19 and corresponding to FIG. 19.

FIG. 21 is a view of yet other modifications of the first and second boss parts and a state of engagement of the first boss part and the first cam part with each other and corresponding to FIG. 19.

FIG. 22 is a view of a state of engagement of the second boss part and the second cam part with each other in the yet other modifications in FIG. 21 and corresponding to FIG. 21.

FIG. 23 is a perspective view of an input device according to a second exemplary embodiment of the present invention.

FIG. 24 is a perspective view of a device main body in the second exemplary embodiment seen from above.

FIG. 25 is a perspective view of a slider in the second exemplary embodiment seen from above.

FIG. 26 is a perspective view of the slider in FIG. 25 seen from below.

FIG. 27 is a perspective view of a lower side of the slider in FIG. 25 turned up and seen from above.

FIG. 28 is a perspective view of a rotor in the second exemplary embodiment seen from above.

FIG. 29 is a perspective view of the rotor and a vibrator disposed on the lower side of the slider in the second exemplary embodiment and seen from below.

FIG. 30 is a plan view of the slider, the rotor and a biasing member in the second exemplary embodiment housed in the device main body and seen from above.

FIG. 31 is a partial enlarged view of a part surrounded with an alternate long and short dash line in FIG. 30.

FIG. 32 is a schematic view of a state of engagement of a first boss part and a first cam part with each other in the second exemplary embodiment.

### DESCRIPTION OF EMBODIMENTS

Prior to describing exemplary embodiments of the present invention, problems found in conventional techniques will now briefly be described herein.

In the input device in the above-described Patent Literature 1, the paired bent chips of the shaft are respectively and rotatably supported on the paired connecting chips and the shaft rotates about the intermediate portion of the shaft as a center of rotation to thereby suppress the tilting of the touch panel. The stabilizer also suppresses the tilting about an axis of the shaft. However, the shaft and the stabilizer are housed to cross each other, which complicates a structure and assembly in the device.

The present disclosure has been made with the above-described points in view and it is an object of the present disclosure to add a contrivance to an internal structure of an input device to thereby make operational feelings in pushing operation uniform with a simple structure.

Hereinafter, the exemplary embodiments of the present invention will be described in detail with reference to the drawings. Description of the following exemplary embodiments are fundamentally examples and are not intended to restrict the present invention and applications or usage of the present invention.

### First Exemplary Embodiment

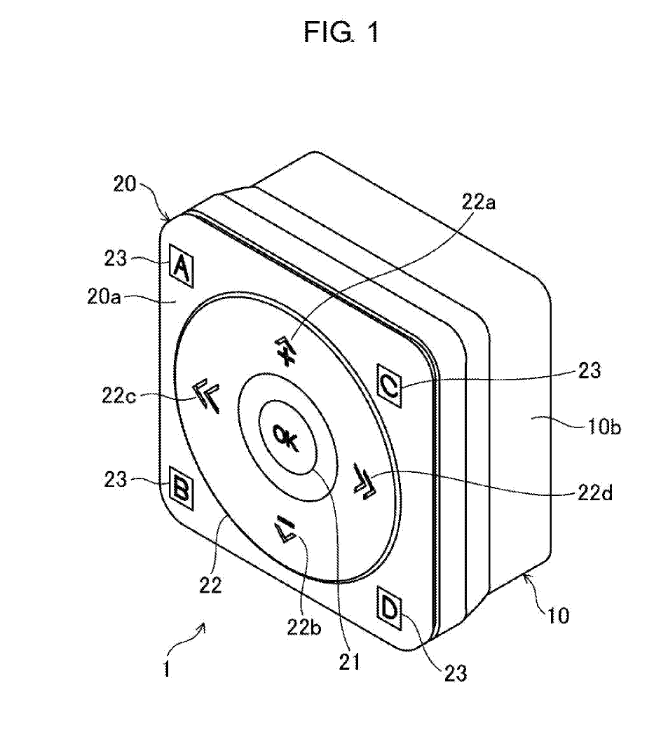

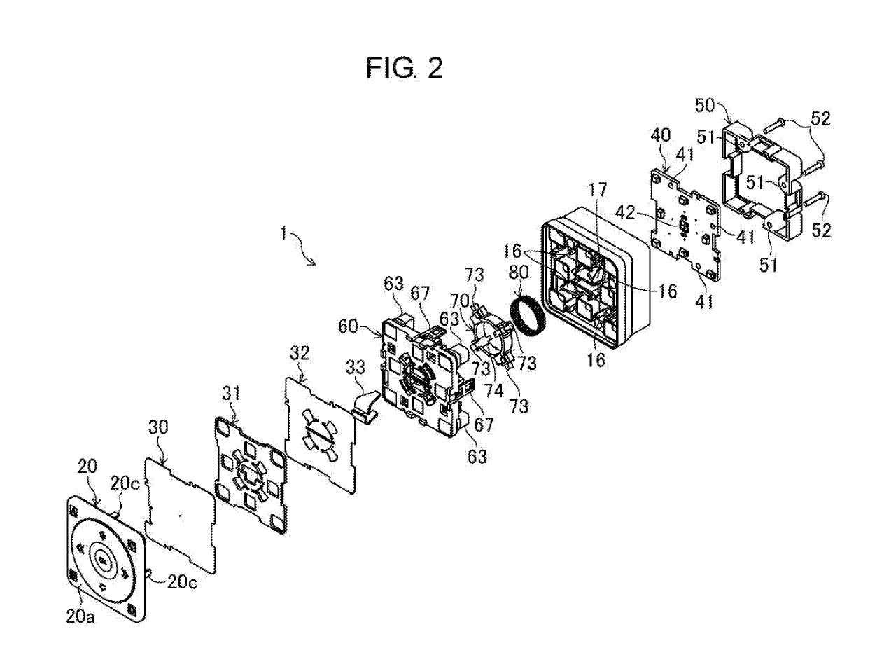

FIGS. 1 and 2 show a whole structure of input device 1 according to the first exemplary embodiment of the present invention. Input device 1 is applied as a vehicle-mounted input device provided to a meter, an instrument panel near blow outlets of an air conditioner, or a steering wheel in a vehicle, for example, and capable of being operated by pushing by a user such as a driver.

Hereinafter, in the following description, a vertical positional relationship of input device 1 will be expressed by describing a side on which operating unit 20 (described later) as an upper side (up) and a side on which device main body 10 is disposed as a lower side (down). A plan view shows a state seen in a vertical direction. Such a positional relationship is not relevant to an actual vertical direction when input device 1 is installed.

Input device 1 includes device main body 10, operating unit 20, sensor unit 30, substrate 40, base part 50, slider 60, rotor 70, and biasing member 80 as main component members. The respective members will be described below in detail.

### (Device Main Body)

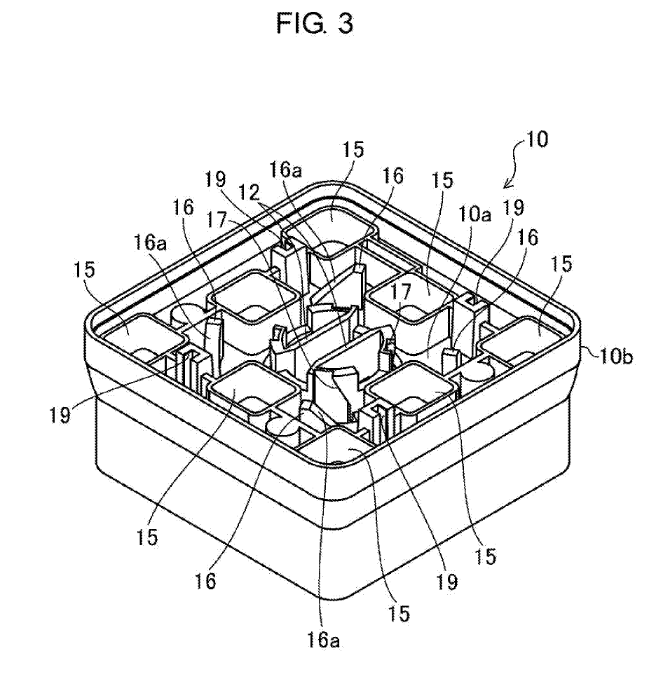

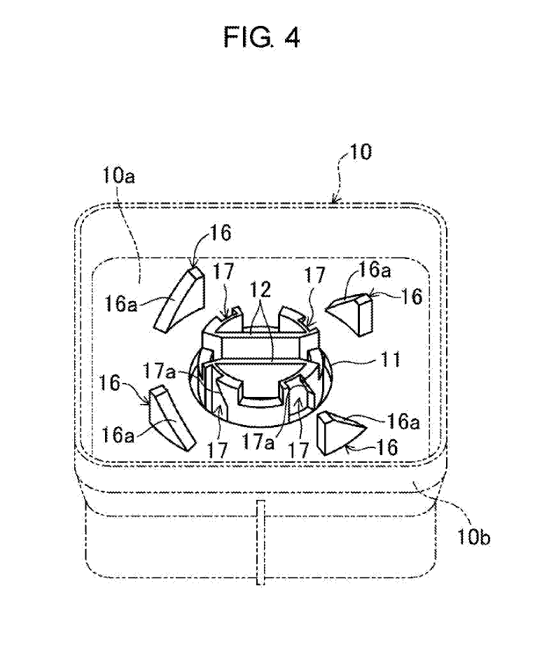

Device main body 10 is a rectangular cylinder open upward and having a bottom and forms a casing of input device 1. As shown in FIGS. 3 to 5, device main body 10 has bottom part 10a having a substantially rectangular shape in plan view and side wall part 10b having a rectangular cylindrical shape extending upward from a whole peripheral edge of bottom part 10a and housing space S having operating unit 20 as an upper wall portion is formed in a portion surrounded with bottom part 10a and side wall part 10b.

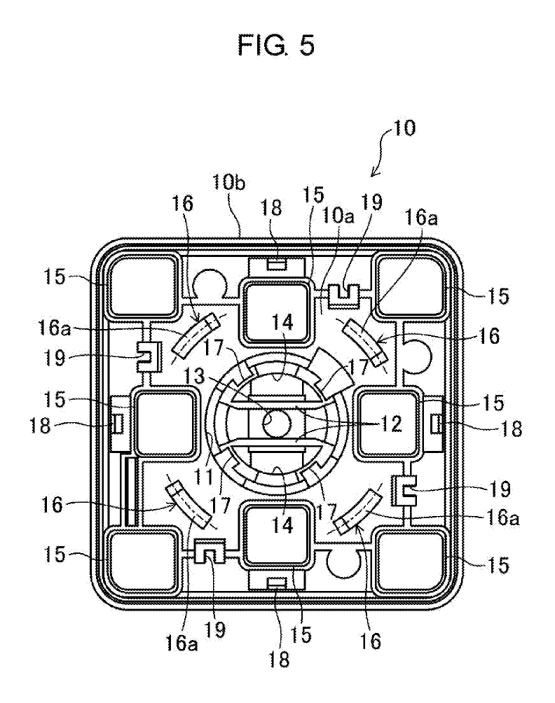

As shown in FIGS. 5, 16, and 17, annular recessed portion 11 recessed in an annular shape centered at a central portion of bottom part 10a of device main body 10 is formed near the central portion and biasing member 80 (described later) is housed in annular recessed portion 11. At bottom part 10a of device main body 10, two middle column parts 12, 12 substantially in shapes of semicylinders extending upward are formed at an interval to protrude integrally with a portion of bottom part 10a corresponding to a radially inner side of annular recessed portion 11 (the central portion of bottom part 10a). Both middle column parts 12, 12 have side wall parts that are in shapes of flat faces, positioned at an interval, and facing each other on opposite sides of the central portion of bottom part 10a and side wall parts that are in shapes of are faces and standing to form a single circle in plan view. Between both middle column parts 12, 12 (at the center of bottom part 10a), insertion hole 13 having a circular shape in plan view is formed throughout a length direction (vertical direction) of middle column parts 12. Insertion hole 13 is formed so that presser 66 formed integrally with slider 60 (described later) is inserted through insertion hole 13 to be able to lift and lower.

As shown in FIG. 5, translucent part 14 that permits a light beam emitted from first light-emitting diode (LED) element 43 on substrate 40 (described later) pass through is formed through a cylindrical inside of each of middle column parts 12.

At bottom part 10a of device main body 10, a plurality of (eight, in an example shown in the figures) support column parts 15, 15, . . . standing upward and having substantially rectangular cylindrical shapes are formed integrally around both middle column parts 12 near side wall part 10b and internal spaces in respective support column parts 15 have substantially rectangular shapes in plan view and pass through respective support column parts 15 in the vertical direction.

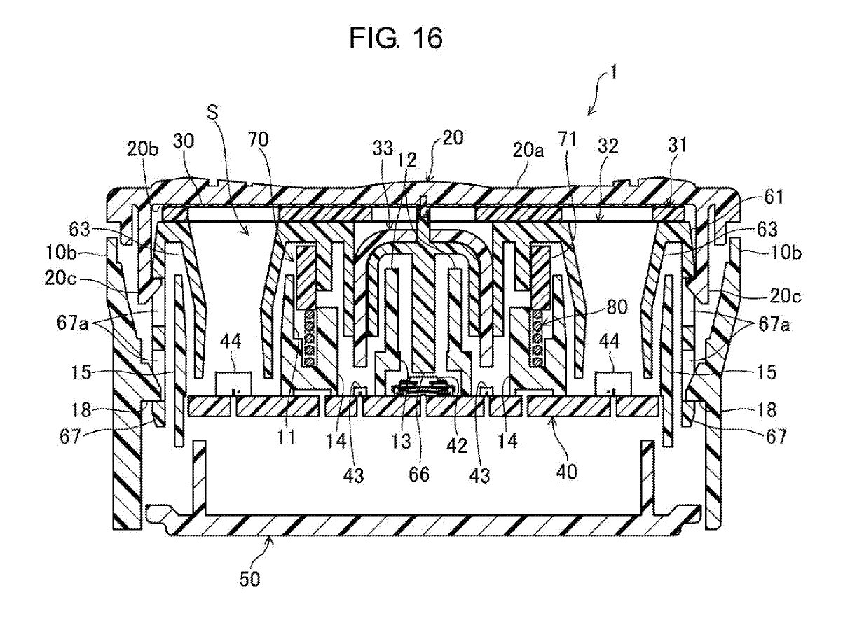

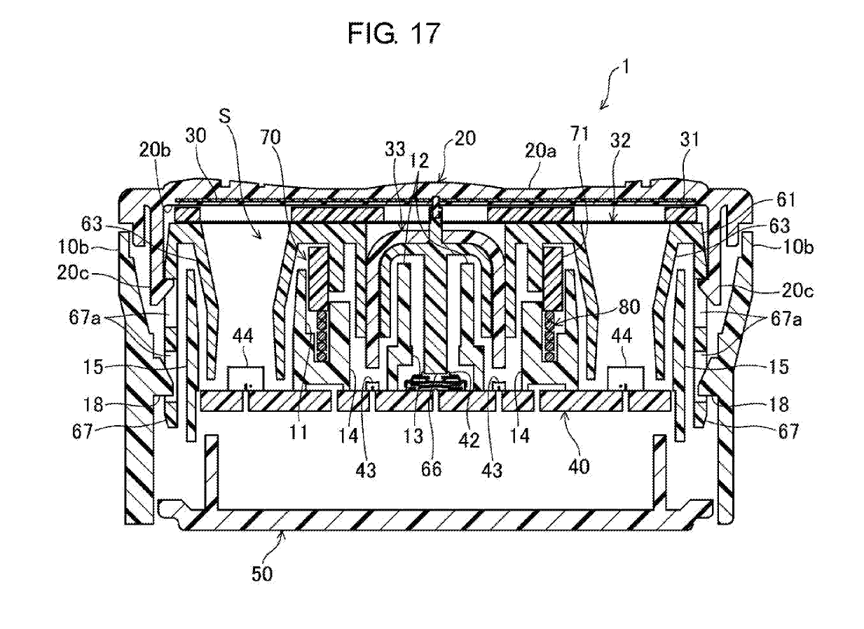

As also shown in FIGS. 16 and 17, lock part 18 for locking slider 60 (described later) while allowing slider 60 to lift and lower is provided substantially at a center in a width direction of each of sides of an inner face of side wall part 10b, at the position facing an outer side of corresponding one of support column parts 15.

As shown in FIGS. 3 to 5, a plurality of (four, in the example shown in the figures) first cam parts 16, 16, . . . protruding upward from bottom part 10a around both middle column parts 12, 12 are formed integrally with device main body 10. Respective first cam parts 16 extend along outer peripheral faces of the side wall parts, having the arc shapes, of both middle column parts 12, 12 and extend in curved shapes about the center of bottom part 10a as an arc center in plan view and the plurality of first cam parts 16, 16, . . . are arranged at equal angular intervals along a circumferential direction. On an upper face of each of first cam parts 16, cam face 16a sloping downward in the circumferential direction (counterclockwise direction in the example shown in the figures) is formed.

On the other hand, in the outer peripheral face of the side wall part, having the arc shape, of each of middle column parts 12, a plurality of (two, in the example shown in the figures) second cam parts 17, 17 are formed for each middle column part 12. Second cam parts 17 are portions formed into recessed shapes by cutting out portions of the outer peripheral face of the side wall part, having the arc shape, of each of middle column parts 12 and the plurality of second cam parts 17, 17, . . . of both middle column parts 12, 12 are disposed at equal angular intervals along the circumferential direction. On one of side faces (one side face of the recessed portion), which face each other in the circumferential direction, of each of second cam parts 17, cam face 17a sloping upward toward operating unit 20 in the circumferential direction (clockwise direction in the example shown in the figures) is formed.

First and second cam parts 16 and 17 are formed as cam parts that respectively guide first and second boss parts 73, 74 (described later) as engagement parts as a result of pushing operation or cancellation of the pushing operation of operating unit 20.

As shown in FIGS. 3 and 5, a plurality of (four, in the example shown in the figures) guide grooves 19, 19, . . . protruding upward from bottom part 10a of device main body 10 are formed integrally with bottom part 10a. In guide grooves 19, 19, . . . , guide ribs 69 provided to slider main body 61 (described later) are fitted.

### (Operating Unit)

Operating unit 20 is a member that can be pushed downward toward device main body 10 and has operating face 20a (surface) that has a substantially rectangular shape in plan view and that permits light pass through. As shown in FIG. 2, on a back face of operating unit 20, claw parts 20c, 20c protruding downward are formed near respective four sides. By locking respective claw parts 20c to upper ends of hole parts 67a formed in respective lock parts 67 of slider 60 (described later) (see FIGS. 16 and 17), operating unit 20 is mounted to device main body 10 so as to form housing space S between a space above device main body 10 and operating unit 20.

As shown in FIG. 1, on operating face 20a of operating unit 20, first push part 21 having a substantially circular shape is disposed at a center, second push part 22 having a substantially annular shape and a width is formed around first push part 21, and four third push parts 23, 23, . . . are respectively disposed around second push part 22 and in respective corner portions of operating face 20a. Here, second push part 22 is formed not for pushing of a whole part of second push part 22 but for pushing of direction selectors 22a to 22d respectively disposed at arm positions of a cross, direction selectors 22a to 22d being parts of second push part 22. To third push parts 23, 23, . . . , clear indications such as “A”, “B”, “C”, “D” are respectively given to show positions to be pushed in the example shown in the figures. Respective indicating parts of respective push parts 21, 22, 23 are formed to be lit up by irradiation of light beams from respective LED elements 43, 44 (described later).

### (Sensor Unit)

Sensor unit 30 is provided below operating unit 20 and determines a pushed position of operating face 20a of operating unit 20 when respective push parts 21, 22, 23 of operating unit 20 are pushed. As sensor unit 30, a capacitance touch sensor in a shape of a transparent sheet is suitable, for example.

### (Substrate and Base Part)

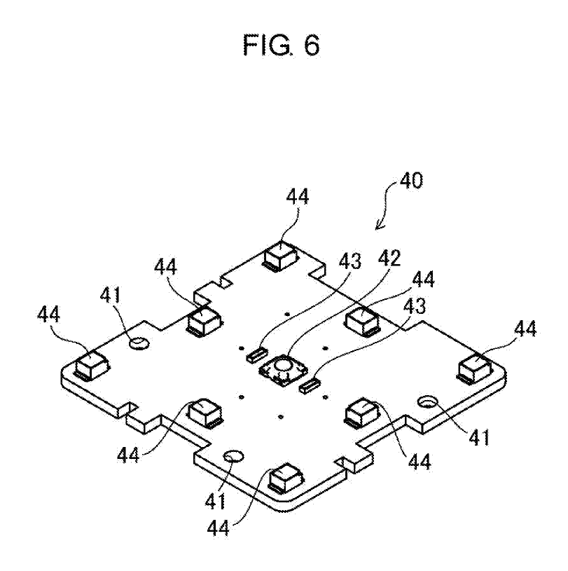

As shown in FIG. 2, side wall part 10b of device main body 10 extends farther downward than bottom part 10a and substrate 40 and base part 50 are housed in a lower space surrounded with an extending portion of side wall part 10b and bottom part 10a. Substrate 40 has a substantially rectangular shape and three substrate-side screw holes 41, 41, . . . (see FIG. 6) are formed near a peripheral edge of substrate 40. On the other hand, base part 50 has a rectangular shape with a bottom and three base part-side screw holes 51, 51, . . . are formed at positions of base part 50 corresponding to respective substrate-side screw holes 41 when base part 50 is laid on substrate 40. Substrate 40 and base part 50 are mounted and fixed to the lower side of device main body 10 by screws 52 that are respectively inserted into respective substrate-side screw holes 41 and respective base part-side screw holes 51 and fastened to device main body 10 in this state.

As shown in FIGS. 2 and 6, switch unit 42 formed by a light touch switch, for example, is provided at a substantially central position of a surface (upper face) of substrate 40. As shown in FIGS. 16 and 17, switch unit 42 is disposed at a central portion of device main body 10 so as to face a tip end face (lower end face) of presser 66 in insertion hole 13 in the vertical direction when substrate 40 is mounted and fixed to a lower side of bottom part 10a of device main body 10.

On the surface of substrate 40, paired first LED elements 43, 43 are disposed. Specifically, first LED elements 43, 43 are disposed to face each other with switch unit 42 interposed between first LED elements 43, 43 and the light beams are emitted to slider translucent units 62, 62 of slider main body 61 (described later) from first LED elements 43, 43 so as to light up first push part 21 of operating unit 20.

Furthermore, a plurality of (eight, in the example shown in the figures) second LED elements 44, 44, . . . having a size larger than that of first LED elements 43 are arranged on the surface of substrate 40. Specifically, second LED elements 44 are respectively disposed in respective corner portions and substantially at centers in width directions of respective sides of the surface of substrate 40 and second LED elements 44 are formed to emit light beams into respective protruding parts 63 of slider main body 61 (described later) so as to respectively light up second and third push parts 22, 23.

As shown in FIG. 2, in order to allow the light beams emitted from first and second LED elements 43, 44 to appropriately light up respective push parts 21 to 23 of operating unit 20, input device 1 is provided with light leakage preventing sheet 31 (shading sheet), diffusion preventing sheet 32 (diffusion sheet), and lens guide 33.

### (Slider)

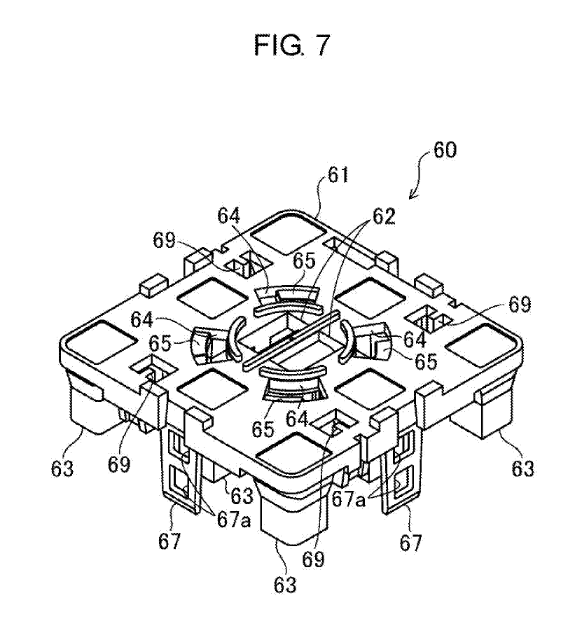

Slider 60 is housed in housing space S so as to be able to lower or lift in a direction toward or away from device main body 10 as the result of the pushing operation or the cancellation of the pushing operation of operating unit 20. As shown in FIG. 7, slider 60 includes slider main body 61 having a substantially rectangular plate shape in plan view.

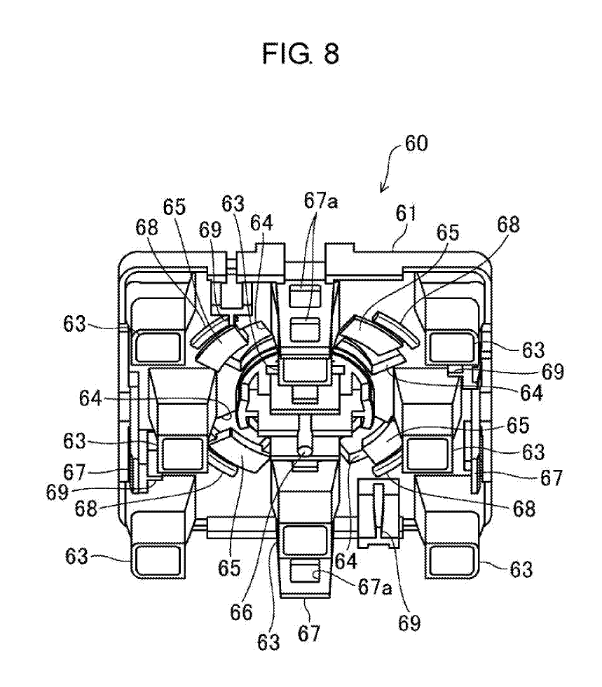

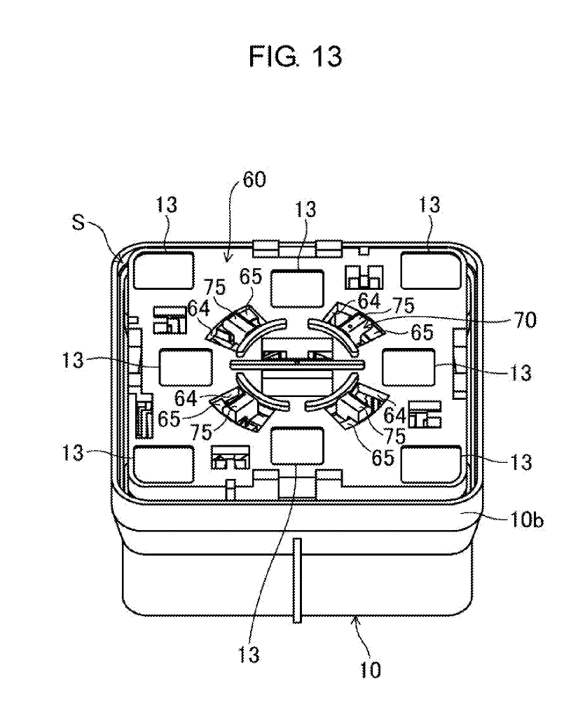

Near a center of slider main body 61, paired slider translucent parts 62, 62, that permits the light beams from respective first LED elements 43 pass through and that are formed by openings in substantially rectangular shapes, are formed through slider main body 61. As also shown in FIG. 8, a plurality of (eight, in the example shown in the figures) protruding parts 63, 63, . . . protruding downward and having rectangular cylindrical shapes are formed integrally with a lower portion of slider main body 61 so as to correspond to support column parts 15, 15, . . . of device main body 10. An internal space of each of protruding parts 63 has a substantially rectangular shape in plan view and vertically passes through protruding part 63 so that each of protruding parts 63 is fitted in corresponding one of support column parts 15 of device main body 10 (see FIGS. 16 and 17). As a result of the fitting of protruding parts 63 in support column parts 15, slider 60 is housed in side wall part 10b of device main body 10 so as not to be able to turn with respect to device main body 10 in housing space S as also shown in FIG. 13.

Here, as shown in FIGS. 16 and 17, the light beams emitted from respective second LED elements 44 disposed on substrate 40 pass through respective protruding parts 63 and illuminate operating unit 20 from below when slider 60 is housed in housing space S. In other words, second and third push parts 22, 23 are respectively lit up by the light beams emitted from respective second LED elements 44 through respective protruding parts 63.

At a center in a width direction of each of sides of slider main body 61, lock part 67 protruding downward from slider main body 61 and having a rectangular plate shape is integrally formed with slider main body 61 on an outer side of each of protruding parts 63. Through each of lock parts 67, two hole parts 67a, 67a having substantially rectangular shapes are formed while arranged in the vertical direction. As shown in FIGS. 16 and 17, claw parts 20c of operating unit 20 are respectively locked to the upper ends of upper hole parts 67a. Lock parts 18 of device main body 10 are respectively locked to lower ends of lower hole parts 67a and, as a result, slider 60 is locked to be able to lift and lower with respect to device main body 10.

Around a central portion of slider main body 61, a plurality of (four, in the example shown in the figures) through holes 64, 64, . . . in shapes of arcs (sectors) centered at the central portion of slider main body 61 are concentrically formed at equal angular intervals along a circumferential direction. From an outer peripheral wall face of each of through holes 64, lock stage 65 extending radially inward from a lower portion of the outer peripheral wall face and having a flat plate shape is formed to protrude. Lock stage 65 locks each of turning lock parts 75 of rotor 70 (described later) to support rotor 70 so that rotor 70 can turn, an upper face of lock stage 65 is recessed downward in a step shape from an upper face of slider main body 61, and one end portion in a width direction of lock stage 65 in the circumferential direction is partially cut out to allow insertion of turning lock part 75 from below.

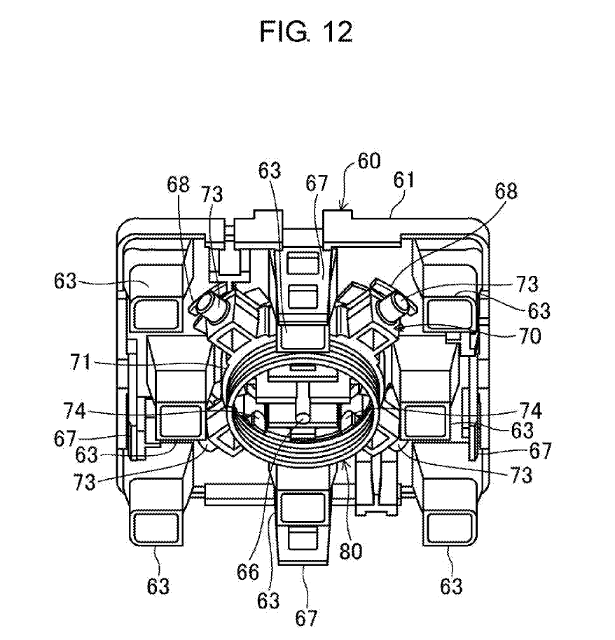

As shown in FIG. 8, on a lower face of slider main body 61, a plurality of rib parts 68, 68, . . . are formed around a central portion of the lower face and at equal angular intervals along the circumferential direction. Each of rib parts 68 is formed in a curved shape in bottom view so as to extend in the circumferential direction about the central portion of slider main body 61. As shown in FIG. 12, when rotor 70 (described later) is disposed on a lower side of slider 60, respective rib parts 68 come in contact with respective first boss parts 73 (described later) from above.

As shown in FIG. 8, with the lower portion of slider main body 61, presser 66 protruding downward and having a shape of a round rod is integrally formed at a substantially central position. As shown in FIGS. 16 and 17, presser 66 is formed at the position directly above switch unit 42 to face switch unit 42 when presser 66 is inserted into insertion hole 13 of device main body 10. In other words, presser 66 can lower or lift in the direction toward or away from device main body 10 together with slider main body 61 and configured to press switch unit 42 when presser 66 is caused to lower together with slider main body 61 by the pushing operation of operating unit 20.

As shown in FIGS. 7 and 8, a plurality of (four, in the example shown in the figures) guide ribs 69, 69, . . . are formed respectively and integrally with portions of slider main body 61 near outer peripheral sides of slider main body 61. The guide ribs 69, 69, . . . are fitted in guide grooves 19, 19, . . . described above. As a result, slider main body 61 can lift and lower in the vertical direction with guide ribs 69, 69, . . . guided by guide grooves 19, 19, . . . .

### (Rotor)

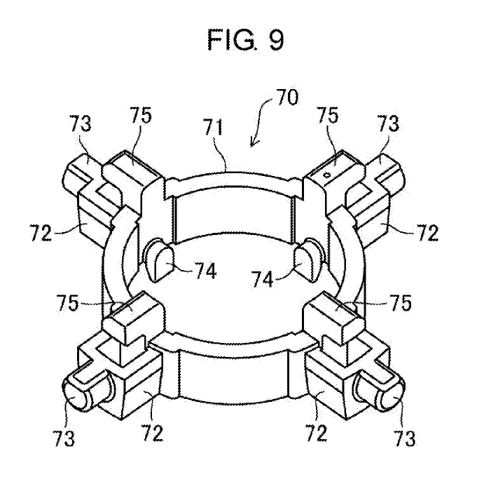

Rotor 70 is provided to be able to turn with respect to slider 60. As shown in FIGS. 9 to 12, rotor 70 includes rotor main body 71 positioned directly above annular recessed portion 11 of device main body 10 and having an annular shape and rotor main body 71 is housed in housing space S while fitted over peripheries of middle column parts 12, 12 of device main body 10 and biased upward by biasing member 80 (described later) in annular recessed portion 11.

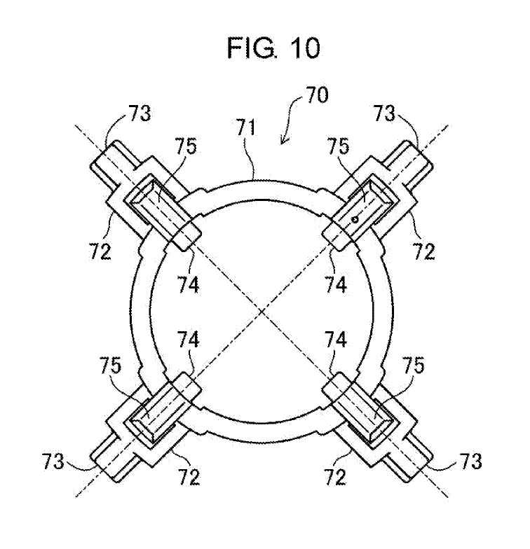

As shown in FIGS. 9 and 10, mount parts 72, 72, . . . protruding outward in a radial direction of rotor main body 71 and having substantially rectangular parallelepiped shapes are formed integrally with an outer peripheral side of rotor main body 71 and at positions at equal angular intervals (90° in the example shown in the figures) in the circumferential direction. First boss part 73 protruding outward in the radial direction of rotor main body 71 and having a substantially circular columnar shape is formed integrally with an outer side face of each of mount parts 72. On an upper end face of rotor main body 71, turning lock parts 75 having substantially L shapes are formed at portions corresponding to respective mount parts 72. Each of turning lock parts 75 stands upward from the upper end face of rotor main body 71 and then extends outward in the radial direction of rotor main body 71 to be positioned above each of mount parts 72 and a portion of each of turning lock parts 75 positioned above each of mount parts 72 slides in the circumferential direction while locked to the upper face of each of lock stages 65 of slider 60 as shown in FIG. 13. With this structure, rotor 70 can turn in the circumferential direction with respect to slider 60.

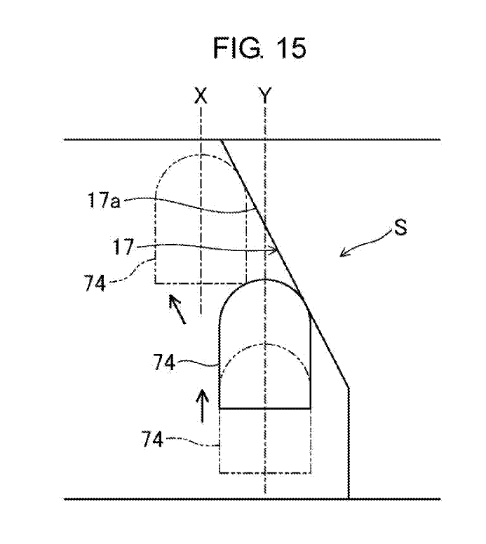

As shown in FIGS. 9 and 10, a plurality of (four, in the example shown in the figures) second boss parts 74, 74, . . . protruding inward in the radial direction of rotor main body 71 are formed integrally with an inner peripheral side of rotor main body 71 and at positions at equal angular intervals (90° in the example shown in the figures) in the circumferential direction. Respective second boss parts 74 are arranged at positions of rotor main body 71 aligned with respective first boss parts 73 in the circumferential direction. In other words, each of second boss parts 74 is disposed along an extended line of a protruding direction of first boss parts 73 the protruding direction of which faces second boss part 74 with rotor main body 71 interposed between the protruding direction and second boss part 74. As shown in FIG. 15, an upper portion of a tip end portion of each of second boss parts 74 is formed as an arc face having a substantially semicircular shape in section and a lower portion of each of second boss parts 74 is formed in a substantially rectangular shape in section. As shown in FIG. 12, respective second boss parts 74 are disposed at lower positions than respective first boss parts 73.

Each of first boss parts 73 and each of second boss parts 74 form an engagement part and first and second boss parts 73, 74 are respectively formed at intervals in the circumferential direction on rotor main body 71. Above-described first and second cam parts 16, 17 provided to device main body 10 serve as cam parts that respectively guide first and second boss parts 73, 74 (engagement parts) to turn rotor 70 with respect to slider 60 to lift or lower presser 66 when slider 60 is caused to lift or lower by the pushing operation or the cancellation of the pushing operation of operating unit 20.

Although rotor main body 71 has the annular shape in the present exemplary embodiment, rotor main body 71 may have a polygonal ring shape. However, if rotor main body 71 has corners, it is necessary to produce a clearance to prevent the corners from interfering with other component members. Therefore, from a viewpoint of miniaturization, the annular shape is preferable.

Although rotor main body 71 has the annular shape in the present exemplary embodiment, rotor main body 71 may have a circular columnar shape or a polygonal columnar shape, if it is unnecessary to light up first push part 21. In this case, first and second boss parts 73, 74 are formed to protrude outward in the radial direction of rotor main body 71.

### (Biasing Member)

Biasing member 80 is for biasing slider 60 upward. As also shown in FIG. 12, biasing member 80 is formed by a compression coil spring, for example, and disposed below rotor main body 71 mounted to slider 60. As shown in FIGS. 16 and 17, biasing member 80 is disposed while housed in annular recessed portion 11 of device main body 10 and in contact with bottom part 11a of annular recessed portion 11 and a lower end of rotor main body 71. As a result, biasing member 80 biases slider 60 upward as well as rotor 70 in housing space S.

### (Operation of Input Device)

Next, actions of input device 1 associated with the pushing operation and the cancellation of the pushing operation will be described in detail.

First, a case in which a portion near a center of operating unit 20, i.e., a portion near first push part 21 is pushed will be described. A user pushes the portion near first push part 21 of input device 1 in an initial state with his or her fingertip or the like. Specifically, the user pushes operating unit 20 down toward device main body 10 to such an extent that slider main body 61 lowers. At this time, sensor unit 30 determines which of push parts 21 to 23 a pushed position of operating face 20a of operating unit 20 is. Here, sensor unit 30 determines that first push part 21 is the pushed position. When the pushing operation is conducted, the upper face of slider main body 61 is pushed by operating unit 20 and slider 60 is pushed down to move toward device main body 10 in housing space S. At this time, slider 60 do not turn with respect to device main body 10, because respective guide ribs 69 are fitted in respective guide grooves 19 of device main body 10.

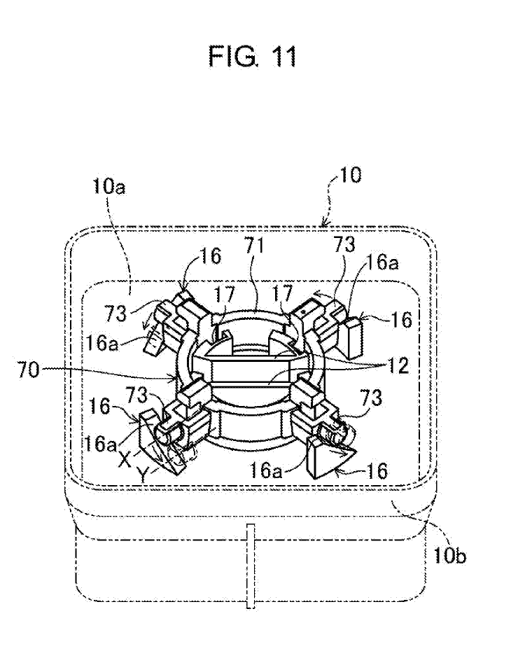

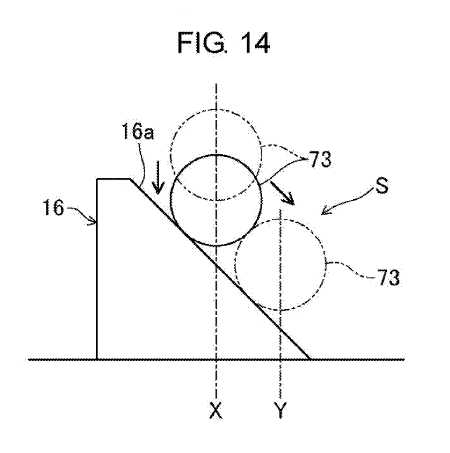

When the pushing operation is conducted, rotor 70 moves toward device main body 10 together with slider 60 in space S against a biasing force of biasing member 80, because respective first boss parts 73 on an outer peripheral side of rotor 70 are pushed downward by respective rib parts 68. As a result of this action, as shown in FIGS. 11 and 14, each of first boss parts 73 comes in substantially uniform contact with cam face 16a of each of first cam parts 16 of device main body 10. Here, a position of rotor 70 immediately before respective first boss parts 73 come in contact with cam faces 16a of respective first cam parts 16 is defined as “reference position X”.

If the pushing operation is further continued, respective first boss parts 73 lower while in sliding contact with cam faces 16a of respective first cam parts 16. In other words, after respective first boss parts 73 come in contact with respective cam faces 16a, rotor 70 moves toward device main body 10 while turning in the counterclockwise direction (direction shown by arrows in FIGS. 11 and 14) in housing space S. Then, each of first boss parts 73 slides by a predetermined distance with respect to cam face 16a and stops. Here, a position where respective first boss parts 73 stop is defined as “turning position Y”.

If the pushing operation is conducted in this manner, respective first boss parts 73 come in sliding contact with cam faces 16a of respective first cam parts 16 to lower while turning rotor 70 from reference position X to turning position Y against the biasing force of biasing member 80. In other words, when the pushing operation of operating unit 20 moves slider 60 toward device main body 10, respective first cam parts 16 come in contact with respective first boss parts 73 to guide respective first boss parts 73 to cause rotor 70 to turn from reference position X to turning position Y with respect to slider 60.

When rotor 70 is positioned at reference position X, as shown in FIG. 16, the tip end of presser 66 is positioned above and at a predetermined distance from switch unit 42. When rotor 70 turns to turning position Y, as shown in FIG. 17, the tip end of presser 66 pushes switch unit 42, i.e., switch unit 42 is turned ON (or turned OFF). As a result of actuation of switch unit 42, a signal corresponding to one of push parts 21 to 23 is output from the input device based on a result of determination of the pushed position of operating face 20a of operating unit 20 by sensor unit 30.

On the other hand, if the pushing operation in input device 1 is cancelled, rotor 70 is pushed back together with slider 60 by the biasing force of biasing member 80 so as to move away from device main body 10 in housing space S. At this time, as shown in FIG. 15, each of second boss parts 74 on an inner peripheral side of rotor 70 comes in substantially uniform contact with cam face 17a of each of second cam parts 17 in the outer peripheral face of each of middle column parts 12, 12 of device main body 10 and lifts while in sliding contact with cam face 17a. In other words, after respective second boss parts 74 come in contact with cam faces 17a of respective second cam parts 17, rotor 70 moves away from device main body 10 while turning in a clockwise direction (direction shown by arrows in FIGS. 11 and 14), that is an opposite direction to the direction in the pushing operation, in housing space S. Then, each of second boss parts 74 slides by a predetermined distance with respect to cam face 17a and stops.

If the pushing operation is cancelled in this manner, respective second boss parts 74 come in sliding contact with cam faces 17a of second cam parts 17 to lift while turning rotor 70 from turning position Y to reference position X due to the biasing force of biasing member 80. In other words, when the pushing operation is cancelled and slider 60 moves away from device main body 10, respective second cam parts 17 come in contact with respective second boss parts 74 to guide respective second boss parts 74 to cause rotor 70 to turn from turning position Y to reference position X with respect to slider 60. As a result of the cancellation of the pushing operation, the tip end of presser 66 returns into the state in which the tip end is positioned away from switch unit 42 (i.e., state shown in FIG. 16).

Next, a case, in which a portion near a periphery of operating unit 20, e.g., a pushed position marked as “A”, i.e., third push part 23 at an upper left portion in FIG. 1 is pushed, will be described. The user pushes the portion near the pushed position “A” of third push part 23 of input device 1 in the initial state with his or her fingertip or the like. At this time, sensor unit 30 determines that the pushed position “A” of operating face 20a of operating unit 20 is pushed. When the pushing operation is conducted, the upper face of slider main body 61 is pushed by operating unit 20 and slider 60 is pushed down to move toward device main body 10 in housing space S. At this time, because of a clearance between each of guide ribs 69 of slider 60 and each of guide grooves 19 of device main body 10, a portion of a pushed position “D” positioned diagonally to the pushed position “A” tilts slightly with respect to the pushed position “A”.

As a result, when the pushing operation is conducted, first boss part 73 on the outer peripheral side of rotor 70 is pushed downward by rib part 68 at the portion of the pushed position “A” and therefore first boss part 73 near a lower portion of the pushed position “A” comes in contact with cam face 16a of first cam part 16 of device main body 10 near the lower portion of the pushed position “A” as shown in FIG. 14. On the other hand, because the portion of the pushed position “D” is slightly tilted compared with the portion of the pushed position “A”, second boss part 74 on the inner peripheral side of rotor 70 comes in contact with cam face 17a of second cam part 17 near the lower portion of the pushed position “D” as shown by “reference position X” in FIG. 15 before first boss part 73 comes in contact with cam face 16a of first cam part 16.

If the pushing operation is further continued, first boss part 73 near the lower portion of the pushed position “A” lowers while in sliding contact with cam face 16a of first cam part 16 that is in contact with first boss part 73 and second boss part 74 near the lower portion of the pushed position “D” lowers while in sliding contact with cam face 17a of second cam part 17 that is in contact with second boss part 74.

In this manner, if the portion near the periphery of operating unit 20 is pushed, first and second boss parts 73 and 74 of rotor 70 are respectively guided by cam faces 16a, 17a of first and second cam parts 16, 17 of device main body 10, which allows rotor 70 to turn with respect to slider 60 and prevents lifting and lowering attitudes of operating unit 20 from tilting with respect to a lifting and lowering direction.

If the above-described pushing operation is cancelled, in a reverse order of the pushing operation, second boss part 74 near the lower portion of the pushed position “A” lifts while in contact with cam face 17a of second cam part 17 that is in contact with second boss part 74 due to the biasing force of biasing member 80 as shown in FIG. 15. Then, as shown in FIG. 14, first boss part 73 near the lower portion of the pushed position “D” lifts while in sliding contact with cam face 16a of first cam part 16 that is in contact with first boss part 73.

As described above, in input device 1 according to the present exemplary embodiment, because the plurality of first and second boss parts 73, 74 (engagement parts) arranged at intervals in the circumferential direction of rotor 70 are respectively guided by cam faces 16a, 17a of the plurality of first and second cam parts 16, 17 arranged at intervals in the circumferential direction of device main body 10 when slider 60 lifts or lowers due to the pushing operation or the cancellation of the pushing operation of operating unit 20, rotor 70 turns with respect to slider 60 and the lifting and lowering attitudes of operating unit 20 do not tilt with respect to the lifting and lowering direction.

The structure can be recapitulated as follows. When slider 60 is moved toward or away from device main body 10 by the pushing operation of operating unit 20, first cam parts 16 respectively come in contact with first boss parts 73 to guide first boss parts 73 to cause rotor 70 to turn from reference position X to turning position Y or from turning position Y to reference position X with respect to slider 60. When the pushing operation of operating unit 20 moves slider 60 toward or away from device main body 10, second cam parts 17 respectively come in contact with second boss parts 74 to guide second boss parts 74 to cause rotor 70 to turn from reference position X to turning position Y or from turning position Y to reference position X with respect to slider 60.

More specifically, respective first boss parts 73 are brought in sliding contact with cam faces 16a of first cam parts 16 by the operation of operating unit 20 to turn rotor 70 from reference position X to turning position Y or from turning position Y to reference position X and respective second boss parts 74 are brought in sliding contact with cam faces 17a of second cam parts 17 by the operation of operating unit 20 to turn rotor 70 from reference position X to turning position Y or from turning position Y to reference position X.

### Workings and Effects of First Exemplary Embodiment

Therefore, with the structure according to the present exemplary embodiment, because respective boss parts 73, 74 are guided by respective cam parts 16, 17, parts of a pressing force or the biasing force of biasing member 80 in the direction toward or away from device main body 10 is converted into the turning of rotor 70, the pressing force or the biasing force generated by the pushing operation or the cancellation of the pushing operation of operating unit 20. As rotor 70 turns, presser 66 can lower or lift in the direction toward or away from device main body 10 together with slider 60 while maintaining the appropriate attitude (the state in which presser 66 does not tilt with respect to a vertical straight line passing through the center of device main body 10 in the present exemplary embodiment) in housing space S so that a direction of the pressing force or the biasing force does not deviate. In other words, operating unit 20 locked to slider 60 is controlled to lift or lower in the constant attitude in housing space S due to the engagement and the guiding of boss parts 73, 74 with and by cam parts 16, 17. As a result, whichever position of operating unit 20 is pushed, the attitude of the lowering of operating unit 20 is maintained stably and presser 66 presses switch unit 42. On the other hand, when the pushing operation is cancelled, operating unit 20 lifts in the stably controlled attitude to return to an original position. Therefore, with simple cam mechanisms, it is possible to make user's operational feelings uniform.

In input device 1 according to the present exemplary embodiment, rotor 70 is provided with the plurality of first and second boss parts 73, 74 and device main body 10 is provided with first cam parts 16 and second cam parts 17, first cam parts 16 guiding first boss parts 73 to cause rotor 70 to turn from reference position X to turning position Y when slider 60 is moved toward device main body 10 by the pushing operation of operating unit 20 and second cam parts 17 guiding second boss parts 74 to cause rotor 70 to return from turning position Y to reference position X when the pushing operation of operating unit 20 is cancelled and slider 60 moves away from device main body 10. Because the structure in which first boss parts 73 are guided by first cam parts 16 and the structure in which second boss parts 74 are guided by second cam parts 17 are separate from each other in this manner, it is possible to further stably control the attitudes of the lifting and the lowering of operating unit 20 according to respective conditions resulting from the pushing operation and the cancellation of the pushing operation.

In input device 1 according to the present exemplary embodiment, respective first boss parts 73 are brought in sliding contact with cam faces 16a by the pushing operation of operating unit 20 and lower while turning rotor 70 from reference position X to turning position Y and, on the other hand, respective second boss parts 74 are brought in sliding contact with cam faces 17a by the cancellation of the pushing operation and lift while turning rotor 70 from turning position Y to reference position X. The structures of the cam mechanisms are simple and it is possible to stably control, with the simple cam structures, the attitudes of the lifting and the lowering of operating unit 20 according to the respective conditions resulting from the pushing operation and the cancellation of the pushing operation.

In input device 1 according to the present exemplary embodiment, while first boss parts 73 are formed at the positions at the equal angular intervals in the circumferential direction on the outer peripheral side of rotor main body 71 having the annular shape, second boss parts 74 are formed at the positions at the equal angular intervals in the circumferential direction on the inner peripheral side of rotor main body 71. Because respective first and second boss parts 73, 74 are respectively arranged at the equal angular intervals on rotor main body 71, the parts of pressing force or the biasing force generated by the pushing operation or the cancellation of the pushing operation become more likely to be transmitted uniformly to rotor main body 71, rotor 70 turns smoothly, and it is possible to further stably control the attitudes of the lifting and the lowering of operating unit 20. Although both of first and second boss parts 73, 74 may be formed on one of the outer side and the inner side of rotor main body 71, as compared with this structure, the structure in the present exemplary embodiment makes it easier to arrange first boss parts 73 and second boss parts 74 on rotor main body 71 while preventing interference between first boss parts 73 and second boss parts 74 and can reduce a height of whole input device 1.

In input device 1 according to the present exemplary embodiment, because presser 66 is provided integrally with slider 60, it is possible to directly transmit the pressing force, generated by the pushing operation, from slider 60 to presser 66.

Furthermore, in input device 1 according to the present exemplary embodiment, sensor unit 30 that determines the pushed position of operating face 20a (surface) of operating unit 20 when operating unit 20 is pushed is provided below operating unit 20. In this way, it is possible to impart a plurality of input functions according to the pushed positions of operating face 20a while maintaining user's uniform operational feelings irrespective of the pushed position of operating face 20a.

### Modifications of First Exemplary Embodiment

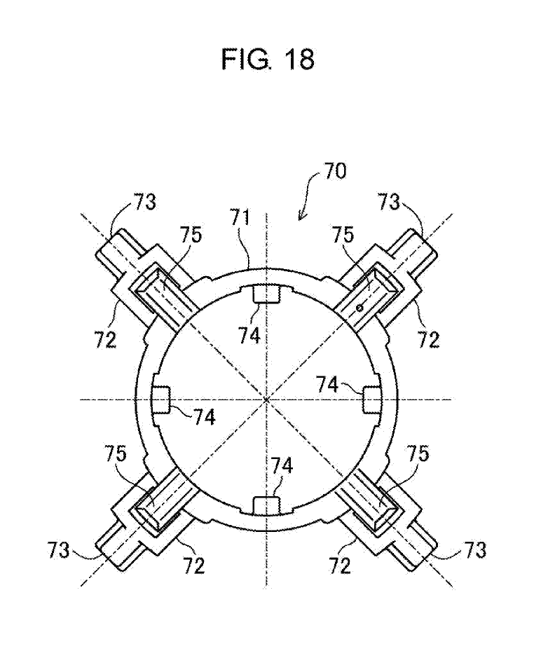

Although respective second boss parts 74 are arranged on the inner peripheral side of rotor main body 71 to face respective first boss parts 73 in input device 1 according to the above-described first exemplary embodiment, the present invention is not limited to this structure. For example, as shown in FIG. 18, respective second boss parts 74 may be disposed at positions displaced by predetermined angles (45° in an example shown in the figure) from protruding directions of respective first boss parts 73.

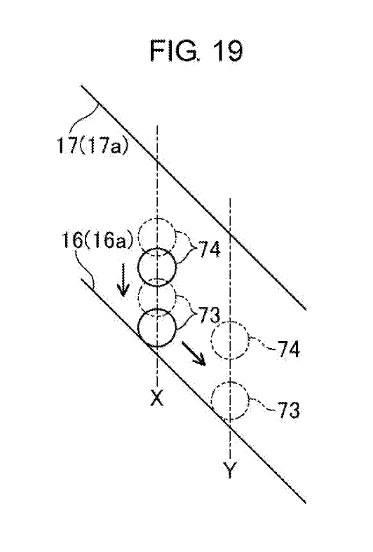

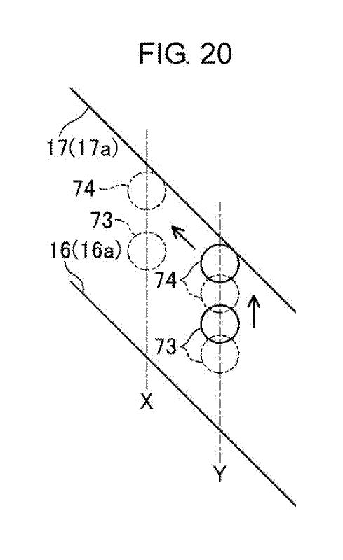

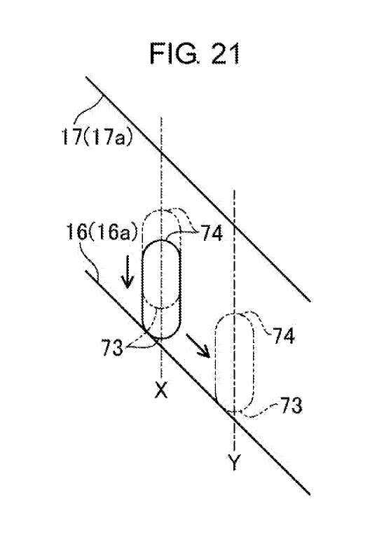

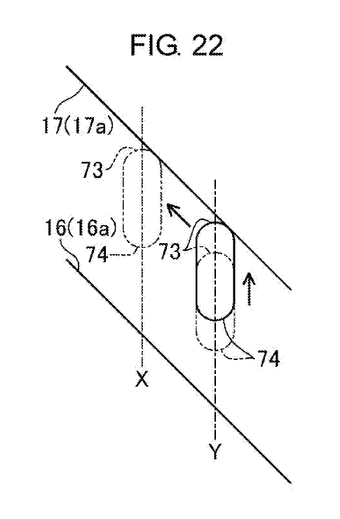

First and second boss parts 73, 74 may be formed on one of an outer peripheral side and an inner peripheral side of rotor main body 71. In this case, for example, respective first boss parts 73 and respective second boss parts 74 may be formed as separate bodies as shown in FIGS. 19 and 20 or respective first boss parts 73 and respective second boss parts 74 may be formed integrally as shown in FIGS. 21 and 22. With these modifications, it is possible to simplify a structure of rotor 70 and it is easy to manufacture rotor 70.

### Second Exemplary Embodiment

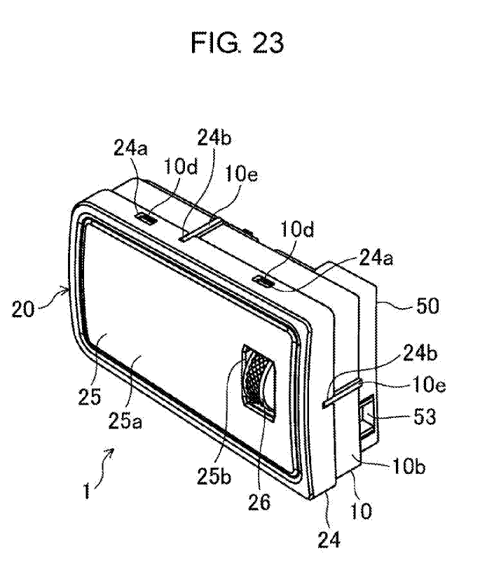

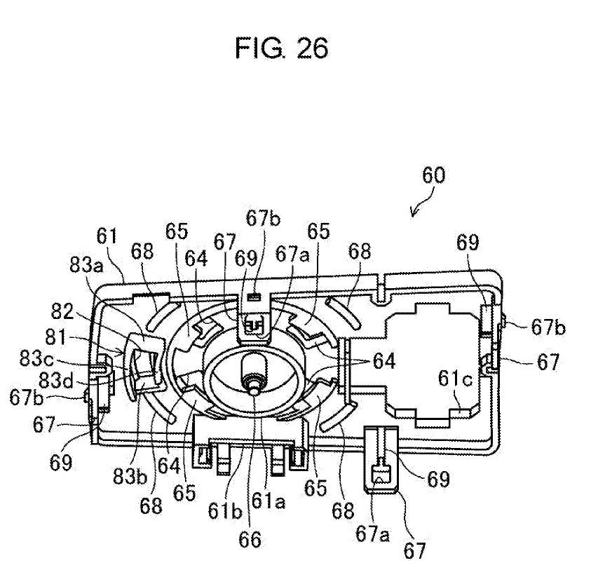

FIGS. 23 to 32 show input device 1 according to a second exemplary embodiment of the present invention. The present exemplary embodiment is different from the first exemplary embodiment especially in structures of rotor 70 and biasing member 80. In the following description, portions that are the same as in FIGS. 1 to 22 will be provided with similar reference signs and will not be described in detail.

FIG. 23 shows a whole structure of input device 1 according to the present exemplary embodiment. As in the first exemplary embodiment, input device 1 includes device main body 10, operating unit 20, sensor unit 30, substrate 40, base part 50, slider 60, rotor 70, and biasing member 80 as main component members. The respective members will be described below.

### (Device Main Body)

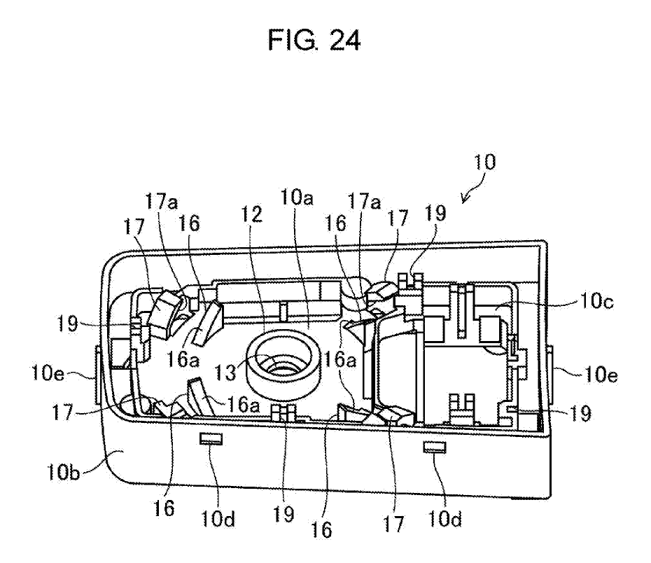

As shown in FIG. 24, at a central portion of bottom part 10a of device main body 10, middle column part 12 extending upward and having a substantially cylindrical shape is formed to protrude. Insertion hole 13 having a circular shape in plan view is formed through middle column part 12. As in the first exemplary embodiment, insertion hole 13 is formed so that presser 66 formed integrally with slider 60 is inserted through insertion hole 13 to be able to lift and lower.

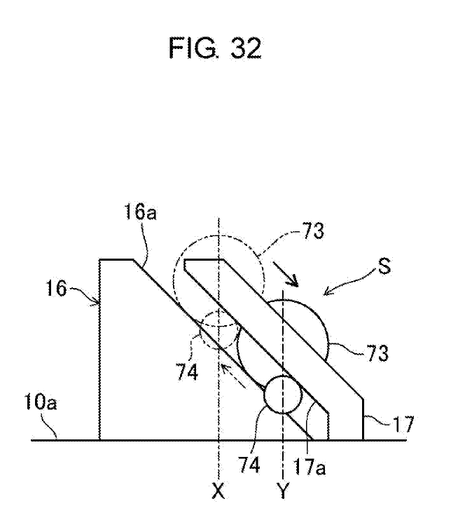

A plurality of (four, in an example shown in the figures) first cam parts 16, 16, . . . protruding upward from bottom part 10a around middle column part 12 are formed integrally with device main body 10. As in the first exemplary embodiment, respective first cam parts 16 extend along an outer peripheral face of middle column part 12 and extend in curved shapes about a center of middle column part 12 as an arc center in plan view and the plurality of first cam parts 16, 16, . . . are arranged at equal angular intervals along a circumferential direction. As shown in FIGS. 24 and 32, on an upper face of each of first cam parts 16, cam face 16a sloping downward in the circumferential direction (counterclockwise direction, in the example shown in the figures) is formed.

Unlike in the first exemplary embodiment, a plurality of (four, in the example shown in the figures) second cam parts 17, 17, . . . protruding upward from bottom part 10a are formed integrally with device main body 10 on an outer side of first cam parts 16, 16, . . . . Respective second cam parts 17 extend in curved shapes about the center of middle column part 12 as an arc center in plan view. Second cam parts 17, 17, . . . are arranged at positions facing outer side faces of respective first cam parts 16 and at equal angular intervals along the circumferential direction of first cam parts 16, 16, . . . . As also shown in FIG. 32, on a lower face of each of second cam parts 17, cam face 17a sloping upward toward operating unit 20 in the circumferential direction (clockwise direction in the example shown in the figures) is formed.

At one side portion (a right portion of device main body 10 in the example shown in the figures) in a longitudinal direction of device main body 10, housing part 10c for housing roller unit 26 (see FIG. 23) of operating unit 20 (described later) is formed. On each of long sides of an outer side face of side wall part 10b, lock lugs 10d, 10d to be locked to lock holes 24a, 24a provided to operating unit 20 (described later) are formed at an interval in a width direction. Furthermore, substantially at a center in the width direction of each of three sides of the outer side face of side wall part 10b, lock parts 10e, 10e, . . . to be locked to respective lock grooves 24b of operating unit 20 (described later) are formed to protrude. Each of lock parts 10e extends in a shape of a straight line in a vertical direction of device main body 10.

At positions facing respective sides of an inner side face of side wall part 10b, guide grooves 19, 19 protruding upward from bottom part 10a are formed integrally with device main body 10. As in the first exemplary embodiment, respective guide ribs 69 provided to slider main body 61 are respectively fitted in respective guide grooves 19.

### (Operating Unit)

As shown in FIG. 23, operating unit 20 includes frame part 24 supported by device main body 10 while fitted over a periphery of side wall part 10b of device main body 10 and push part 25 that can be pushed downward toward device main body 10 while fitted in an inner periphery of frame part 24.

Frame part 24 is formed in a shape of a four-sided frame along the outer side face of side wall part 10b of device main body 10. On each of long sides of an outer side face of frame part 24, lock holes 24a, 24a for locking of lock lugs 10d, 10d of device main body 10 are formed at an interval in a width direction. Substantially at a center in the width direction of each of three sides of the outer side face of frame part 24, lock grooves 24b, 24b for locking of respective lock parts 10e of device main body 10 is formed.

Push part 25 has an operating face 25a (surface) that has a substantially rectangular shape in plan view and that permits light pass through and pushing operation or flick-input operation is possible when a user touches operating face 25a with his or her finger. Similarly to operating unit 20 in the first exemplary embodiment, on a back face of push part 25, claw parts (not shown) protruding downward are formed near respective four sides and, by locking respective claw parts to hole parts 67a formed in respective lock parts 67 of slider 60 (described later), operating unit 20 is mounted to device main body 10 so as to form housing space S between a space above device main body 10 and operating unit 20.

As shown in FIG. 23, at one side portion of push part 25 (a right portion of push part 25 in the example shown in the figures), window part 25b having a substantially rectangular shape in front view is formed through push part 25. In window part 25b, roller unit 26 housed in housing part 10c of device main body 10 is disposed to be exposed to an outside of input device 1. The user can rotate a roller part of roller unit 26 with his or her finger to thereby adjust a position of a cursor or the like displayed on a screen of an operation panel mounted in a vehicle, for example.

### (Sensor Unit)

A structure of sensor unit 30 in the present exemplary embodiment is basically the same as in the first exemplary embodiment and therefore will be neither shown nor described in detail. However, unlike in the first exemplary embodiment, sensor unit 30 can determine position information in a movement trajectory when the user's finger moves while in contact with operating face 25a of operating unit 20 in flick input. In this way, it is possible to further increase a degree of freedom in an operational feeling of operating unit 20.

### (Substrate and Base Part)

Structures of substrate 40 and base part 50 in the present exemplary embodiment are basically the same as in the first exemplary embodiment and therefore will not be described in detail. Here, substrate 40 is provided with an encoder (not shown) for detecting a rotational position of the roller part of roller unit 26 and the encoder is electrically connected to a terminal outlet 53 (see FIG. 23) provided to an outer side face (right side face in FIG. 23) of base part 50. In other words, by inserting a connecting terminal of an external device into terminal outlet 53, it is possible to output a signal related to the rotational position of roller part detected by the encoder to the external device through terminal outlet 53. In the present exemplary embodiment, first LED elements 43, 43, second LED elements 44, 44, . . . , light leakage preventing sheet 31, diffusion preventing sheet 32, and lens guide 33 used in the first exemplary embodiment are not especially required.

### (Slider)

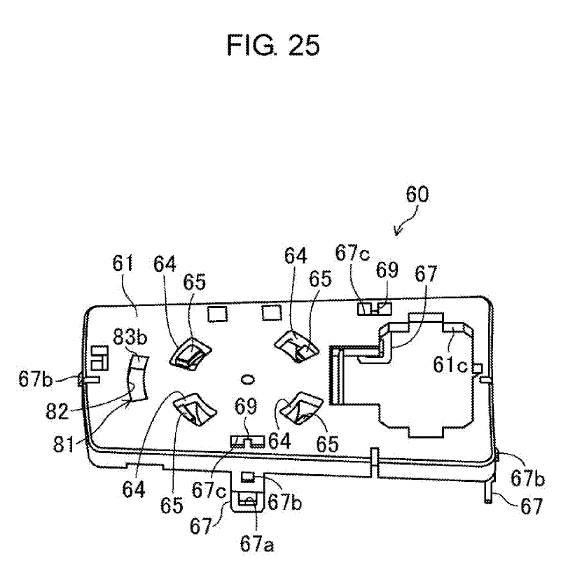

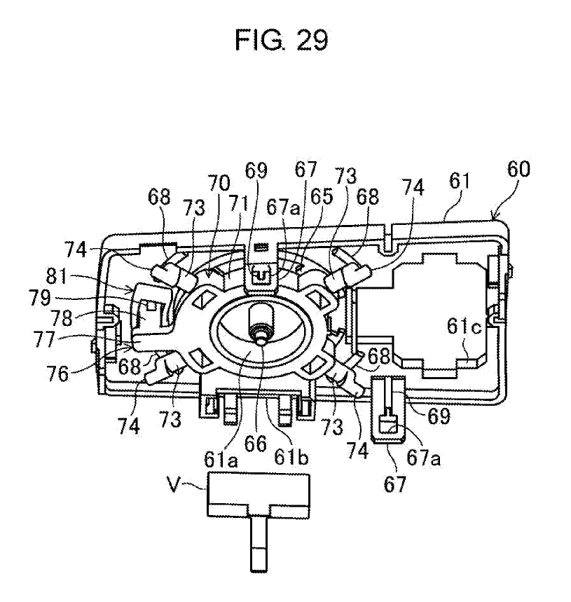

As shown in FIGS. 25 to 27, slider 60 includes slider main body 61 having a substantially rectangular plate shape in plan view. As also shown in FIG. 29, cylindrical part 61a protruding downward and having a cylindrical shape is integrally formed with a lower portion of slider main body 61 at a substantially central position. Cylindrical part 61a is positioned at a position directly above middle column part 12 of device main body 10 and disposed around middle column part 12. A vibrator housing part 61b protruding downward is formed integrally with the lower portion of slider main body 61 on one of long sides of slider main body 61. Vibrator V is for giving a feeling of contact produced by vibration to the user's finger that touches operating face 25a. Furthermore, opening part 61c through which an upper portion of roller unit 26, housed in housing part 10c of device main body 10, is exposed to the outside from window part 25b of push part 25 is formed through one side portion (a right portion in FIGS. 25 to 27) in a longitudinal direction of slider main body 61.

Presser 66 protruding downward and having a shape of a round rod is formed integrally with the lower portion of slider main body 61 at a central position of cylindrical part 61a. On an outer side of cylindrical part 61a, a plurality of (four, in the example shown in the figures) through holes 64, 64, . . . in shapes of arcs (sectors) centered at presser 66 are concentrically formed at equal angular intervals along a circumferential direction. On an outer peripheral wall face of each of through holes 64, lock stage 65 extending radially inward from a lower portion of the outer peripheral wall face and having a flat plate shape is formed to protrude. Moreover, on a lower face of slider main body 61 in an outer side of respective lock stages 65, a plurality of rib parts 68, 68, . . . are formed at equal angular intervals along the circumferential direction.

On respective sides of slider main body 61, lock parts 67, 67, . . . protruding downward from slider main body 61 and having rectangular plate shapes are integrally formed with slider main body 61. Hole part 67a having a substantially rectangular shape is formed through a lower portion of each of lock parts 67. Lock parts (not shown) provided to device main body 10 are locked to lower ends of hole parts 67a. Protruding part 67b protruding outward from slider main body 61 is formed at an upper portion of an outer side face of each of lock parts 67. Respective protruding parts 67b are fitted in groove parts (not shown) provided to device main body 10.

Guide rib 69 extending downward from slider main body 61 is formed integrally with an inner side face of each of lock parts 67. As in the first exemplary embodiment, guide ribs 69 are fitted in guide grooves 19 of device main body 10.

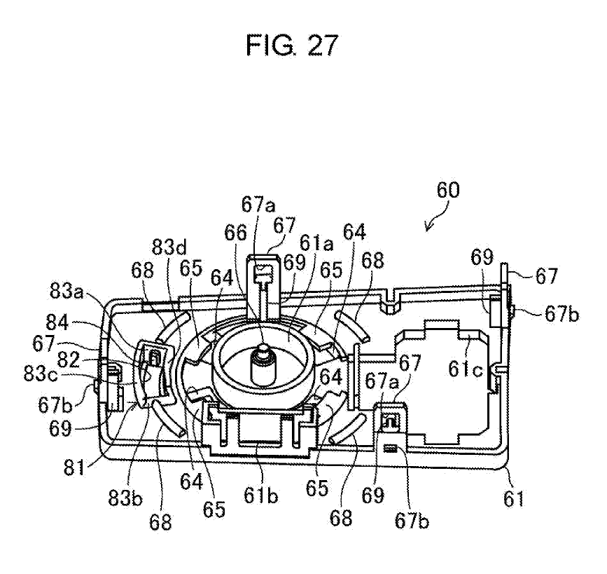

As shown in FIGS. 25 to 27, slider main body 61 is provided with spring retainer 81, that houses biasing member 80 (described later) in such a manner as to compress biasing member 80 along the circumferential direction of the plurality of rib parts 68, 68, . . . , as a structure not provided in the first exemplary embodiment. Specifically, spring retainer 81 has curved hole part 82 having an arc shape and formed through slider main body 61 between rib parts 68, 68 in such a manner as to extend along the circumferential direction of rib parts 68, 68, . . . . Peripheral wall parts 83a to 83d protruding downward from the lower face of slider main body 61 are formed integrally with an outer periphery of curved hole part 82. On an inner side face of peripheral wall part 83a that is one end part in a length direction of curved hole part 82, spring fitter 84 (see FIG. 27) protruding in a circumferential direction of rib parts 68, 68, . . . toward peripheral wall part 83b that is the other end part in a circumferential direction of curved hole part 82 is provided.

### (Rotor)

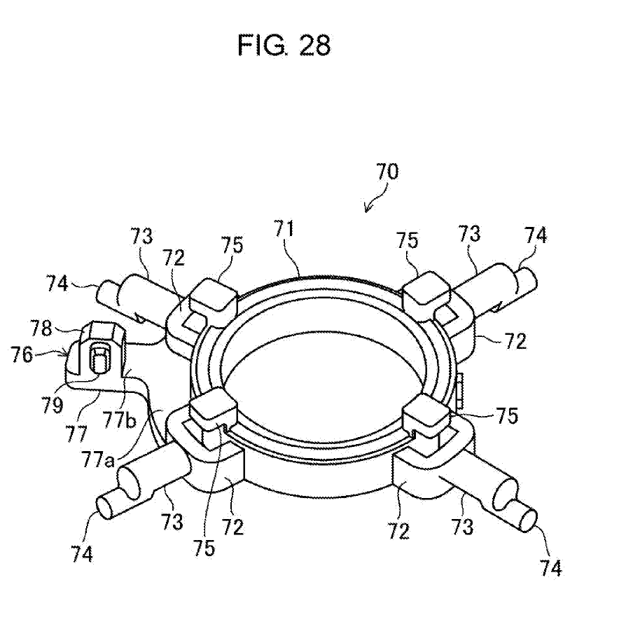

As shown in FIGS. 28 and 29, rotor 70 has rotor main body 71 that is fitted over a periphery of cylindrical part 61a of slider 60 and has an annular shape. Rotor main body 71 is disposed to be positioned directly above middle column part 12 of device main body 10 and fitted over a periphery of middle column part 12 of device main body 10. Mount parts 72, 72, . . . , first boss parts 73, 73, . . . , and turning lock parts 75, 75, . . . are the same as in the first exemplary embodiment and therefore will not described in detail.

Unlike in the first exemplary embodiment, a plurality of (four, in the example shown in the figures) second boss parts 74, 74, . . . protruding outward in a radial direction of rotor main body 71 are formed at an outer peripheral side of rotor main body 71 at positions at equal angular intervals (90° in the example shown in the figures) in a circumferential direction. Specifically, respective second boss parts 74 are formed integrally with tip end parts of respective first boss parts 73. In other words, respective second boss parts 74 are disposed at the positions aligned with respective first boss parts 73 in the circumferential direction of rotor main body 71 and disposed so as to protrude in directions along extended lines of protruding directions of respective first boss parts 73. As also shown in FIG. 32, each of second boss parts 74 is formed in a substantially circular shape in section and disposed so that an upper end portion of each of second boss parts 74 is at a lower position than an upper end portion of each of first boss parts 73.

Next, rotor main body 71 is provided with spring supporter 76 for supporting biasing member 80 in spring retainer 81 when rotor 70 is mounted into slider 60.

Spring supporter 76 has support mount 77 substantially in a plate shape. Support mount 77 has base mount part 77a formed between side faces of mount parts 72, 72 of rotor main body 71 and extending part 77b formed integrally with base mount part 77a. Specifically, base mount part 77a is integrally formed with rotor main body 71 and mount parts 72, 72 in such a manner as to extend radially outward in a substantially arc shape in plan view from an outer peripheral face of rotor main body 71. Extending part 77b is integrally formed with base mount part 77a substantially at a center in a circumferential direction of base mount part 77a and extends outward in a radial direction of rotor main body 71 in a substantially rectangular shape in plan view from a side end portion of base mount part 77a.

A holder 78 protruding vertically from an upper face of extending part 77b and having a wall shape is formed integrally with support mount 77. Spring fitter 79 is formed to protrude from one of wall faces of holder 78 toward one of second boss parts 74 in the circumferential direction of rotor main body 71.

### (Biasing Member)

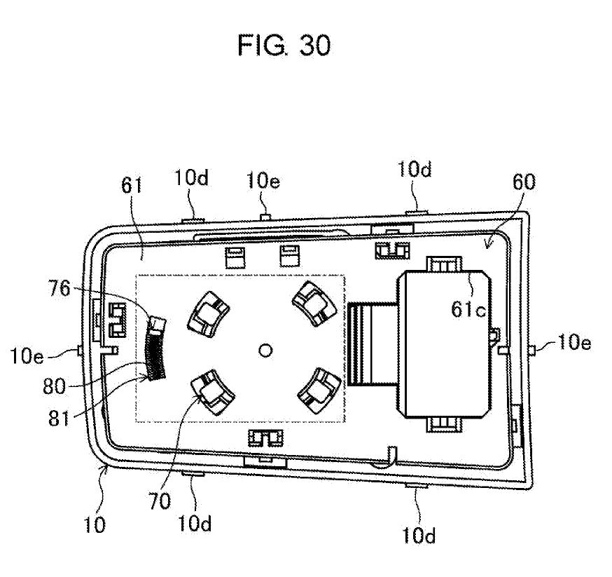

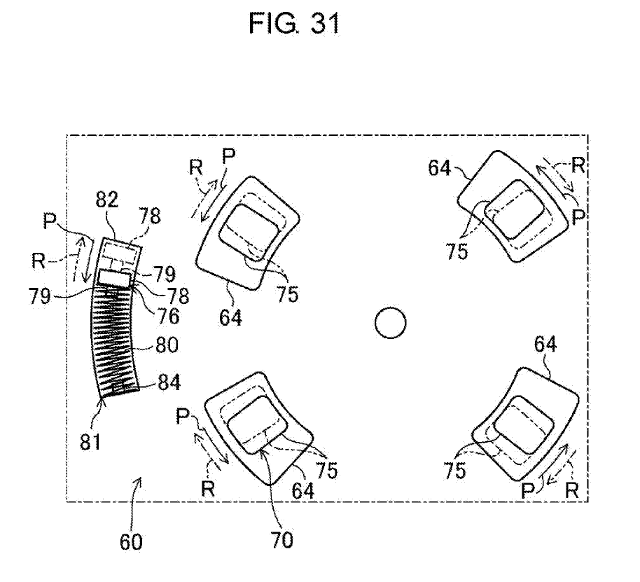

As shown in FIGS. 30 and 31, biasing member 80 is formed by a compression coil spring, for example, and housed in a compressed state in spring housing part 81 of slider main body 61 with one end portion of biasing member 80 fitted over and engaged with spring fitter 84 of spring housing part 81 and the other end portion of biasing member 80 fitted over and engaged with spring fitter 79 of spring supporter 76 of rotor 70. In other words, biasing member 80 (compression coil spring) is disposed in spring housing part 81 so as to expand and contract along the circumferential direction of rotor main body 61 while in contact with slider main body 61 and rotor main body 71.

Here, biasing member 80 biases rotor 70 so that rotor 70 turns in one direction (direction of arrow R shown in FIG. 31) of the circumferential direction with respect to slider 60 when the pushing operation of operating unit 20 is cancelled. When the pushing operation of operating unit 20 is cancelled, rotor 60 moves slider 60 away from device main body 10 while turning from turning position Y to reference position X with respective first boss parts 73 brought in sliding contact with cam faces 16a of first cam parts 16 by a biasing force of biasing member 80.

### (Operation of Input Device)

Next, actions of input device 1 associated with the pushing operation and cancellation of the pushing operation will be described.

A user pushes operating unit 20 of input device 1 in an initial state with his or her fingertip or the like. Specifically, the user pushes push part 25 of operating unit 20 down toward device main body 10 to such an extent that slider main body 61 lowers. At this time, sensor unit 30 determines a pushed position of operating face 25a of push part 25. When the pushing operation is conducted, the upper face of slider main body 61 is pushed by push part 25 and slider 60 is pushed down to move toward device main body 10 in housing space S. At this time, slider 60 do not turn with respect to device main body 10, because respective guide ribs 69 are fitted in respective guide grooves 19 of device main body 10 as in the first exemplary embodiment 1.

When the pushing operation is conducted, rotor 70 moves toward device main body 10 together with slider 60 in housing space S, because respective first boss parts 73 are pushed downward by respective rib parts 68. More specifically, respective first boss parts 73 of rotor 70 lower while in sliding contact with cam faces 16a of respective first cam parts 16 as shown in FIG. 32 and rotor 70 (mount parts 75, 75, . . . in the example shown in the figures) turns in a counterclockwise direction (direction of arrows P in FIG. 31) in housing space S and, at the same time, moves toward device main body 10 as shown in FIG. 31. Then, each of first boss parts 73 slides from reference position X to turning position Y with respect to cam face 16a and stops.

Here, unlike in the first exemplary embodiment, as shown in FIG. 31, when the pushing operation is conducted, holder 78 of spring supporter 76 provided to rotor main body 61 turns toward spring fitter 84 (in the direction of arrow P in FIG. 31) of spring housing part 81 provided to slider main body 61. Biasing member 80 is pushed by holder 78 toward spring fitter 84 (peripheral wall 83a) of spring housing part 81. In other words, biasing member 80 is brought into a compressed state. At this time, resilience for returning holder 78 of spring supporter 76 to an original position (i.e., a position shown by a phantom line in FIG. 31) is generated in biasing member 80.

Due to the resilience of biasing member 80, rotor 70 moves away from device main body 10 while turning in a clockwise direction (direction of arrows R in FIG. 31) that is an opposite direction to the direction in the pushing operation in housing space S. As a result of this action, slider 60 is pushed back upward (toward operating unit 20) with respect to device main body 10 in housing space S. In other words, biasing force for biasing slider 60 upward (toward operating unit 20) with respect to device main body 10 is generated by biasing member 80.

In this manner, if the pushing operation is conducted, respective first boss parts 73 lower while turning rotor 70 from reference position X to turning position Y against the resilience (biasing force) of biasing member 80. Then, as in the first exemplary embodiment, a tip end of presser 66 pushes switch unit 42, i.e., switch unit 42 is turned ON (or turned OFF).

On the other hand, if the pushing operation is cancelled, rotor 70 is pushed back together with slider 60 by the resilience (biasing force) of biasing member 80 so as to move away from device main body 10 in housing space S. At this time, as shown in FIG. 32, respective second boss parts 74 move from turning position Y to reference position X while in sliding contact with cam faces 17a of respective second cam parts 17. Unlike in the first exemplary embodiment, respective first boss parts 73 also move from turning position Y to reference position X while in sliding contact with cam faces 16a of respective first cam parts 16. Rotor 70 moves away from device main body 10 while turning in the clockwise direction (direction of arrows in phantom lines in FIG. 31) that is the opposite direction to the direction in the pushing operation in housing space S.

In this manner, if the pushing operation is cancelled, respective second boss parts 74 lift while turning rotor 70 from turning position Y to reference position X due to the resilience (biasing force) of biasing member 80. As a result of the cancellation of the pushing operation, the tip end of presser 66 returns into the state in which the tip end is positioned away from switch unit 42.

### Workings and Effects of Second Exemplary Embodiment

As described above, in input device 1 according to the present exemplary embodiment, as in the first exemplary embodiment, the plurality of first and second boss parts 73, 74 (engagement parts) arranged at intervals in the circumferential direction of rotor 70 are respectively guided by cam faces 16a, 17a of the plurality of first and second cam parts 16, 17 arranged at intervals in the circumferential direction of device main body 10 when slider 60 lifts or lowers due to the pushing operation or the cancellation of the pushing operation of operating unit 20. Therefore, rotor 70 turns with respect to slider 60 and lifting and lowering attitudes of operating unit 20 do not tilt with respect to a lifting and lowering direction.

When the pushing operation of operating unit 20 is cancelled, rotor 70 moves slider 60 away from device main body 10 while turning from turning position Y to reference position X with respective first boss parts 73 brought in sliding contact with cam faces 16a of respective first cam parts 16 by the resilience (biasing force) of biasing member 80 formed by the coil spring. In other words, even when the pushing operation is cancelled, rotor 70 can move slider 60 away from device main body 10 while kept supported stably by device main body 10 (cam faces 16a of respective first cam parts 16). As a result, even when the pushing operation is cancelled, it is possible to further stabilize the lifting and lowering attitudes of operating unit 20. In an initial state in which the pushing operation is not conducted, respective first boss parts 73 are kept in contact with cam faces 16a of respective first cam parts 16 at reference position X by the resilience of biasing member 80 formed by the coil spring. As a result, in input device 1 according to the present exemplary embodiment, rotor 70 is stably supported by device main body 10 and therefore it is possible to suppress wobbling of operating unit 20 (push part 25) with respect to device main body 10.

Furthermore, respective second boss parts 74 in the present exemplary embodiment are integrally formed with the tip end portions of first boss parts 73 so as to protrude outward in the radial direction of rotor main body 71. Therefore, it is possible to relatively extend a range of movement of each of second boss parts 74 with respect to a rotation angle of rotor 70. As a result, it is possible to make an angle of slope of cam face 17a of each of second cam parts 17 relatively gentle to reduce a vertical thickness of device main body 10. Each of second boss parts 74 is disposed so that the upper end portion of each of second boss parts 74 is at the lower position than the upper end portion of each of first boss parts 73. Therefore, as shown in FIG. 32, a space between the lower end portion of each of first boss parts 73 and the upper end portion of each of second boss parts 74 is relatively narrowed and it is possible to narrow a space between cam face 16a of each of first cam parts 16 and cam face 17a of each of second cam parts 17 as well. As a result, it is possible to reduce the vertical thickness of device main body 10. In other words, it is possible to make input device 1 thin by use of the structures of respective second boss parts 74.

### Other Exemplary Embodiments

Although the plurality of push parts 21 to 23 are provided to operating face 20a of operating unit 20 in input device 1 according to the above-described first exemplary embodiment, the present invention is not limited to this structure and at least one push part may be provided to operating face 20a. If only one push part is provided to operating face 20a, sensor unit 30 does not necessarily have to be provided below operating unit 20.

Although presser 66 is provided at the substantially central position of the lower portion of slider main body 61 in input device 1 according to the above-described first exemplary embodiment, the present invention is not limited to this structure and presser 66 may be provided at a position other than the substantially central position of the lower portion of slider main body 61. Although presser 66 is provided integrally with slider 60 in the above-described exemplary embodiments, presser 66 may be provided at a suitable position of rotor main body 71 of rotor 70, for example. In short, if presser 66 is provided at a position directly above and facing switch unit 42 provided to substrate 40, presser 66 may be provided to either one of slider 60 and rotor 70.

Although biasing member 80 formed by the compression coil spring is provided in input device 1 according to the above-described first exemplary embodiment, the present invention is not limited to this structure. For example, a spring mechanism for biasing presser 66 upward may be mounted into switch unit 42 and the spring mechanism may be used as biasing member 80 to bias presser 66 upward.

Although first boss parts 73, 73, . . . are formed on the outer peripheral side of rotor main body 71 and second boss parts 74, 74, . . . are formed on the inner peripheral side in input device 1 according to the above-described first exemplary embodiment, the present invention is not limited to this structure. For example, the positions where first boss parts 73, 73, . . . and second boss parts 74, 74, . . . are formed may be reversed and second boss parts 74, 74, . . . may be formed on the outer peripheral side of rotor main body 71 while first boss parts 73, 73, . . . may be formed on the inner peripheral side. Second boss parts 74, 74, . . . and first boss parts 73, 73, . . . may be respectively formed on the outer peripheral side of rotor main body 71.

Furthermore, in input device 1 according to the above-described first exemplary embodiment, as in input device 1 according to the above-described second exemplary embodiment, each of second boss parts 74 may be formed integrally with the tip end portion of each of first boss parts 73 and the upper end portion of each of second boss parts 74 may be at a lower position than an upper end portion of each of first boss parts 73.

Although first and second boss parts 73, 74 (engagement parts) are guided by sloping cam faces 16a, 17a of first and second cam parts 16, 17 in input device 1 according to the above-described first exemplary embodiment, the present invention is not limited to this structure. For example, first and second boss parts 73, 74 (engagement parts) may also be formed as sloping faces and the sloping faces and cam faces 16a, 17a may come in sliding contact with each other to turn rotor 70. Furthermore, an internal thread with a large lead angle (e.g., 45°) may be formed on an inner face of rotor main body 71, an external thread to be fitted with the internal thread may be formed on device main body 10, and the external thread and the internal thread may come in sliding contact with each other to turn rotor 70.

Although spring retainer 81 for housing biasing member 80 is provided to slider main body 61 of slider 60 in input device 1 according to the above-described second exemplary embodiment, the present invention is not limited to this structure. For example, spring retainer 81 may be provided to device main body 10. In other words, biasing member 80 only has to be disposed while contracted along the circumferential direction of rotor 70 to thereby bias rotor 70 so that rotor 70 turns in one direction of the circumferential direction with respect to slider 60 when the pushing operation of operating unit 20 is cancelled.

Although the exemplary embodiments of the present invention have been described above, the present invention is not limited to the above-described exemplary embodiments and various changes can be made within a scope of the invention.

### INDUSTRIAL APPLICABILITY

For example, the present invention is industrially applicable to a vehicle-mounted input device provided to an instrument panel or a steering wheel in a vehicle.

### REFERENCE MARKS IN THE DRAWINGS

1: input device
10: device main body
11: annular recessed portion
12: middle column part
16: first cam part
16a: cam face
17: second cam part
17a: cam face
20: operating unit
20a, 25a: operating face (surface)
30: sensor unit
40: substrate
42: switch unit
50: base part
60: slider
61: slider main body
66: presser
70: rotor
71: rotor main body
73: first boss part
74: second boss part
75: turning lock part
80: biasing member
S: housing space
X: reference position
Y: turning position

1. An input device comprising:
a device main body;
an operating unit that forms a housing space between the device main body and the operating unit and that is able to be pushed downward toward the device main body;
a switch unit provided to the device main body;
a slider disposed in the housing space so as not to be able to turn and so as to be able to lower or lift in a direction toward or away from the device main body as a result of pushing operation or cancellation of the pushing operation of the operating unit;
a presser that is provided to the slider and caused to press the switch unit by the pushing operation of the operating unit;
a rotor that is provided to the slider so as to be able to turn and has a plurality of engagement parts disposed at an interval or intervals in a circumferential direction of the rotor; and
a biasing member that biases the slider toward the operating unit,
wherein the device main body has a plurality of cam parts that respectively guide the plurality of engagement parts to turn the rotor with respect to the slider to lower or lift the presser when the slider is caused to lower or lift by the pushing operation or the cancellation of the pushing operation of the operating unit.

2. The input device according to claim 1, wherein
the rotor includes a rotor main body having an annular shape,
each of the plurality of engagement parts is formed by a first boss part and a second boss part that protrude in a radial direction of the rotor main body, and
each of the plurality of cam parts include
first cam part that come in contact with the first boss part to guide the first boss part to cause the rotor to turn from a reference position to a turning position or from the turning position to the reference position with respect to the slider, and
second cam part that come in contact with the second boss part to guide the second boss part to cause the rotor to turn from the reference position to the turning position or from the turning position to the reference position with respect to the slider,
when the slider is caused to move toward or away from the device main body by the pushing operation of the operating unit.

3. The input device according to claim 2, wherein
the first cam part is provided with a cam face sloping downward in a circumferential direction of the rotor main body, the second cam part is provided with a cam face sloping toward the operating unit in the circumferential direction of the rotor main body, and
the first boss part is brought in sliding contact with the cam face of the first cam part by the operation of the operating unit to turn the rotor from the reference position to the turning position or from the turning position to the reference position, and the second boss part is brought in sliding contact with the cam face of the second cam part by the operation of the operating unit to turn the rotor from the reference position to the turning position or from the turning position to the reference position.

4. The input device according to claim 3, wherein
the biasing member is formed by a coil spring that is disposed while contracted along the circumferential direction of the rotor and that biases the rotor to cause the rotor to turn in one direction of the circumferential direction of the rotor when the pushing operation of the operating unit is cancelled, and
the rotor moves the slider away from the device main body while turning from the turning position to the reference position with the first boss part brought in the sliding contact with the cam face of the first cam part by a biasing force of the coil spring when the pushing operation of the operating unit is cancelled.

5. The input device according to claim 3, wherein
the first boss part is formed on an outer peripheral side of the rotor main body to protrude outward in the radial direction of the rotor main body, and
the second boss part is formed on an inner peripheral side of the rotor main body to protrude inward in the radial direction of the rotor main body.

6. The input device according to claim 3, wherein
the first boss part is formed on an outer peripheral side of the rotor main body to protrude outward in the radial direction of the rotor main body, and
the second boss part is formed integrally with tip end portion of the first boss part to protrude outward in the radial direction of the rotor main body, and the second boss part are disposed with upper end portion of the second boss part positioned at lower position than upper end portion of the first boss part.

7. The input device according to claim 1, wherein the presser is provided integrally with the slider.

8. The input device according to claim 1, wherein a sensor unit that determines a pushed position of a surface of the operating unit when the operating unit is pushed is provided below the operating unit.

9. The input device according to claim 8, wherein
the operation of the operating unit by flick input is possible, and
the sensor unit is able to determine position information in a movement trajectory when a finger of a user moves while in contact with the surface of the operating unit in the flick input.
